(19) United States
(12) Patent Application Publication
(10) Pub. No.: US 2008/0205323 A1
(43) Pub. Date: Aug. 28, 2008

(54) Apparatus and method for resource allocation considering buffering in relay wireless communication system

(75) Inventors: Megumi Kaneko, Aalborg (DK); Petar Popovski, Aalborg (DK); Young-Bin Chang, Anyang-si (KR); Eun-Taek Lim, Suwon-si (KR); Pan-Yuh Joo, Seoul (KR); Chang-Yoon Oh, Yongin-si (KR); Cheng Shan, Suwon-si (KR); Yong-Ho Park, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/072,058

(22) Filed: Feb. 22, 2008

(30) Foreign Application Priority Data
Feb. 22, 2007 (KR) 2007-0017699

(51) Int. Cl. H04B 7/14

(52) U.S. Cl. 370/315

(57) ABSTRACT

A relay wireless communication system is provided. A Relay Station (RS) includes a buffer for storing packets to be sent to at least one Mobile Station (MS); a scheduler for allocating resources to the at least one mobile station of which the packets are stored to the buffer; a generator for generating a message which comprises information about at least one mobile station of which packets are not stored to the buffer; and a communicator for sending the message to a Base Station (BS) and sending the packets stored to the buffer to the at least one mobile station allocated the resources.

### CROSS-REFERENCE TO RELATED APPLICATION(S) AND CLAIM OF PRIORITY

This application claims priority under 35 U.S.C. §119(a) to an application filed in the Korean Intellectual Property Office on Feb. 22, 2007 and assigned Serial No. 2007-17699, the disclosure of which is herein incorporated by reference.

### TECHNICAL FIELD OF THE INVENTION

The present invention relates generally to a relay wireless communication system. More particularly, the present invention relates to an apparatus and a method for allocating resources by considering a buffering in the relay wireless communication system.

### BACKGROUND OF THE INVENTION

In a fourth generation (4G) communication system, research has been conducted to provide users with various Quality of Service (QoS) levels at a data rate of about 100 Mbps. Specifically, research of the 4 G communication system has been conducted into a high rate service support to guarantee mobility and QoS in Broadband Wireless Access (BWA) communication systems such as Local Area Network (LAN) systems and Metropolitan Area Network (MAN) systems. Representative 4 G communication systems include Institute of Electrical and Electronics Engineers (IEEE) 802.16 communication systems.

The IEEE 802.16 communication systems employ Orthogonal Frequency Division Multiplexing (OFDM) or Orthogonal Frequency Division Multiple Access (OFDMA) schemes to support a broadband transmission network with physical channels of the wireless communication system. The IEEE 802.16 communication systems seek to ensure mobility of terminals and flexibility of wireless network configuration, and to provide more efficient services in a wireless environment under the severe change of traffic distribution or traffic requirement. For doing so, a multi-hop communication system using a relay station is under consideration.

Using the relay station in the broadband wireless communication system, a coverage area of a base station can be extended and a throughput rate can be enhanced. That is, the data rate can be raised by placing a relay station in a specific area of a poor channel condition. A relay station in a cell boundary enables a terminal outside the coverage of the base station to communicate with the base station. However, in the relay broadband wireless communication system using the relay station, a detailed resource allocation method is not defined yet for the full utilization of the relay station. The current resource allocation method for the relay station mostly takes into account the channel state between the relay station and the terminal. To attain the gain in the substantial channel utilization using the relay station, it is necessary to allocate the resources by considering not only the channel condition but also a queuing state of the relay station; that is, but also a buffering state. In conclusion, what is a needed is a resource allocation method by considering both of the buffering state of the relay station and the channel condition between the terminal and the relay station in the relay wireless communication system.

### SUMMARY OF THE INVENTION

To address the above-discussed deficiencies of the prior art, it is a primary object of the present invention to substantially solve at least the above problems and/or disadvantages and to provide at least the advantages below. Accordingly, an aspect of the present invention is to provide an apparatus and a method for allocating resources based on a buffering state of a relay station in a relay wireless communication system.

Another aspect of the present invention is to provide an apparatus and a method for adjusting ratios of transmit (Tx) intervals for communications of a relay station according to a channel condition between the relay station and a terminal in a relay wireless communication system.

The above aspects are achieved by providing a relay station (RS) in a relay wireless communication system. The realy station includes a buffer for storing packets to be sent to at least one mobile station (MS); a scheduler for allocating resources to the at least one mobile station of which the packets are stored to the buffer; a generator for generating a message which comprises information about at least one mobile station of which packets are not stored to the buffer; and a communicator for sending the message to a base station (BS) and sending the packets stored to the buffer to the at least one mobile station allocated the resources.

According to one aspect of the present invention, a base station in a relay wireless communication system includes a checker for checking a message indicative of a buffering state of a relay station, the message received from the relay station; a scheduler for selecting at least one packet to be sent to the relay station according to the message, determining at least one subchannel where there is no direct link mobile station having better channel condition than a channel condition of the relay station, as resources for communicating with the relay station, and allocating the resources for communicating with the relay station to send the at least one selected packet; and a communicator for transmitting the at least one packet to the relay station.

According to another aspect of the present invention, an operating method of a relay station in a relay wireless communication system includes allocating resources to at least one mobile station of which packets are buffered; generating and sending a message which comprises information about at least one mobile station of which packets are not buffered; and sending the buffered packets to the at least one mobile station allocated the resources.

According to yet another aspect of the present invention, an operating method of a base station in a relay wireless communication system includes receiving a message indicative of a buffering state of a relay station from the relay station; determining at least one subchannel where there is no direct link mobile station having better channel condition than a channel condition of the relay station, as resources for communicating with the relay station; selecting at least one packet to be sent to the relay station according to the message and allocating the resources for communicating with the relay station to send the at least one selected packet; and transmitting the at least one packet to the relay station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates communications of a base station, a relay station, and a terminal in a relay wireless communication system;

FIGS. 2A to 2C illustrate adjustment of a Tx interval ratio of a DL frame in a relay wireless communication system according to an embodiment of the present invention;

FIG. 3 illustrates a relay station in the relay wireless communication system according to an embodiment of the present invention;

FIG. 4 illustrates a base station in the relay wireless communication system according to an embodiment of the present invention;

FIG. 5 illustrates a resource allocating method of the relay station in the relay wireless communication system according to an embodiment of the present invention;

FIG. 6 illustrates a resource allocating method of the base station in the relay wireless communication system according to an embodiment of the present invention;

FIG. 7 illustrates a resource allocating method of the relay station in the relay wireless communication system according to another embodiment of the present invention; and

FIG. 8 illustrates a resource allocating method of the base station in the relay wireless communication system according to another embodiment of the present invention.

### DETAILED DESCRIPTION OF THE INVENTION

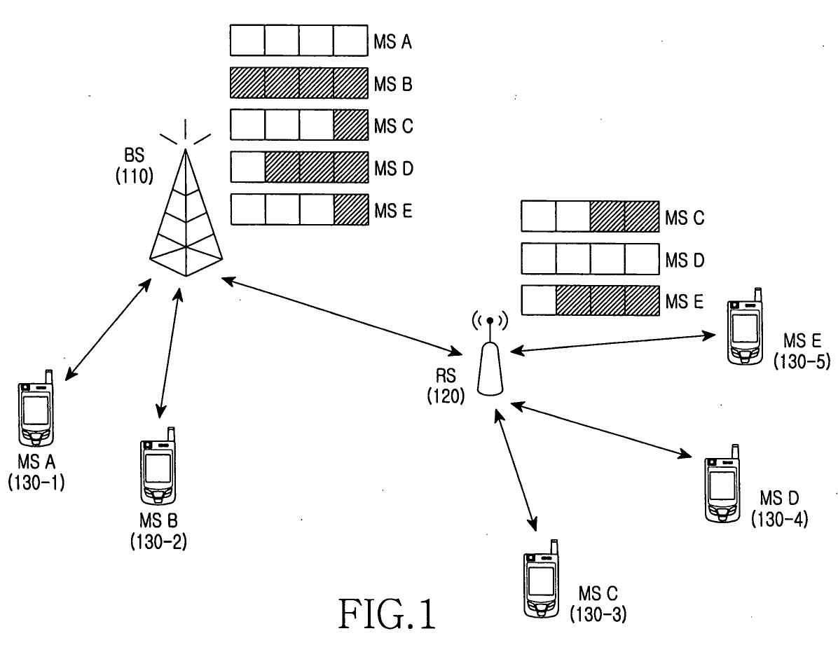

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides a technique for allocating resources according to a buffering state of a relay station (RS) in a relay wireless communication system. An Orthogonal Frequency Division Multiplexing (OFDM) wireless communication system is explained by way of example. The present invention is applicable to any relay wireless communication systems.

A resource allocating method by considering a buffering state of a relay station is described by referring to the drawings.

FIG. 1 illustrates communications of a base station (BS), a relay station (RS), and a mobile station (MS) in a relay wireless communication system. To ease the understanding of the present invention, one BS and one RS are shown in FIG. 1.

MS A 130-1 and MS B 130-2 communicate with the BS 110 through direct links. MS C 130-3, MS D 130-4, and MS E 130-5 communicate with the BS 110 through relay links via the RS 120.

At the start point of the resource allocation for a DownLink (DL) frame, it is assumed that the buffering state of the BS 110 and the RS 120 is shown in FIG. 1. In FIG. 1, the shaded square indicates a buffered packet. The RS 120 buffers transmit packets to the MS C 130-3 and transmit packets to the MS E 130-5 but not transmit packets to the MS D 130-4. The BS 110 buffers transmit packets to the MS B 130-2, transmit packets to the MS C 130-3, transmit packets to the MS D 130-4, and transmit packets to the MS E 130-5, but not transmit packets to the MS A 130-1.

The RS 120 allocates resources to the MS C 130-3 and the MS E 130-5 of which the transmit packets are buffered among the mobile stations. Since the packets of the MS D 130-4 are not buffered, the RS 120 requests the BS 110 to send the packets of the MS D 130-4. For doing so, the RS 120 generates a message indicative of its buffering state and sends the generated message to the BS 110. The structure of the message indicative of the buffering state differs according to various embodiments of the present invention. The BS 110 sends only the packets of the MS D 130-4 to the RS 120 as requested by the RS 120.

The BS 110 allocates resources to the RS 120 and the direct link mobile stations 130-1 and 130-2. The BS 110 temporarily allocates subchannels to the direct link mobile stations of the best channel state on a subchannel basis; that is, to the direct link mobile stations of the highest Received Signal Strength (RSS) or the highest Signal to Interference and Noise Ratio (SINR). In doing so, the MS A 130-1 of which the packets are not buffered is excluded in the resource allocation. Next, the BS 110 identifies an MS of a poorer channel than the channel between the RS 120 and the BS 110 among the mobile stations temporarily assigned the subchannels, and determines the subchannels temporarily allocated to the identified MS as the resource for the communications with the RS 120. Typically, since the RS 120 is positioned in a Line Of Sight (LOS) of the BS 110, the channel condition between the BS 110 and the RS 120 is good in every subchannel. Hence, the BS 110 determines the subchannels temporarily allocated to the direct link MS of the channel state poorer than the channel state between the BS 110 and the RS 120, as a BS-RS link. The BS 110 selects packets to be sent to the RS 120 according to the message indicative of the buffering state of the RS 120. If the subchannels determined as the BS-RS link is not good enough to carry all of the selected packets, the BS 110 reselects part of the requested packets and allocates resources to send the reselected packets. By contrast, if the determined subchannels are able to carry the requested packets, the BS 110 allocates resources to send the selected packets and allocates the remaining resources to the direct link MS.

In the DL frame, an interval for the BS 110 to send packets is distinguished from an interval for the RS 120 to send packets on a time basis. In this embodiment of the present invention, the BS 110 and the RS 120 may divide the DL frame in half on a time basis and use the fixed intervals, or adjust the ratio of the transmit (Tx) interval according to the channel condition between the RS 120 and the relay link mobile stations 130-3, 130-4, and 130-5. When the ratio of the transmit (Tx) interval is adjusted, the BS 110 adjusts the ratio of the Tx interval as follows.

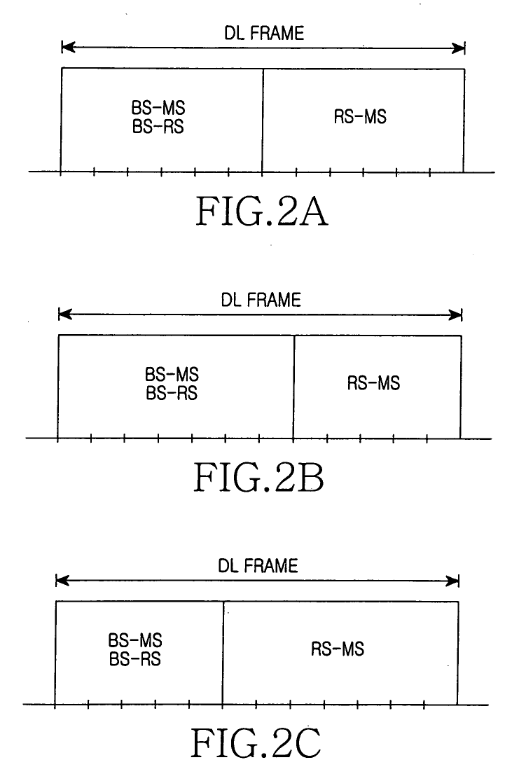

To adjust the ratio of the Tx interval, the BS calculates and compares frame rates τ in three cases as shown in FIGS. 2A to 2C. In specific, the BS 110 calculates the frame rate (hereafter, referred to as a τₖ) in the current Tx interval ratio as shown in FIG. 2A, the frame rate (hereafter, referred to as a τₐ) when the BS Tx interval is increased by one time slot as shown in FIG. 2B, and the frame rate (hereafter, referred to as a τ_{b}) when the RS Tx interval is increased by one time slot as shown in FIG. 2C, and then compares the calculated frame rates. When τₖ is largest, the current setting is determined as the final Tx interval ratio. When τₐ or τ_{b} is the largest, the Tx interval ratio is adjusted to the largest value. Next, the BS 110 optimizes the Tx interval ratio by repeating the calculation and the comparison of the frame rates in those three cases. It is advantageous that the initial setting divides the Tx interval in half at the start point of the Tx interval ratio adjustment. The frame rate τ_{T/2} when the Tx interval is divided in half is calculated using Equation 1:

$${τ}_{T / 2} = \frac{{τ}_{BS - MS} \times T / 2 + {τ}_{RS - MS} \times T / 2}{T} . \qquad [ Eqn . 1 ]$$

In Equation 1, τ_{T/2} is a frame rate when the Tx interval is divided in half, τ_{BS-MS} is a frame rate of the BS-MS link, τ_{RS-MS} is a frame rate of the RS-MS link, and T is a total DL frame time.

The frame rate of each link in Equation 1 is calculated using Equation 2:

$$\begin{matrix}{τ}_{L} = {\sum }_{k} {τ}_{k}^{L} \\ = \frac{1}{N} {\sum }_{n} {\sum }_{k} {τ}_{k , n}^{L} \\ = \frac{1}{N} {\sum }_{n} {\sum }_{k} {c}_{k , n}^{L} \times {u}_{k , n}^{L} \times {r}_{k , n}^{L} \times ( 1 - {BER}_{k , n}^{L} \times {r}_{k , n}^{L} ) .\end{matrix} \qquad [ Eqn . 2 ]$$

In Equation 2, τ_{L} is a frame rate for a random link L, k is an MS index in the link L, N is the number of subchannels, n is a subchannel index, C_{k,n}^{L} is an indicator which is set to 1 when the MS k uses the subchannel n in the link L and set to 0 in other cases, u_{k,n}^{L} is an index indicative of the channel utilization, r_{k,n}^{L} is a data rate of the MS k using the subchannel n in the link L, and BER_{k,n}^{L} is a Bit Error Rate (BER) of the MS k using the subchannel n in the link L. Herein, BER_{k,n}^{L} is predicted using the channel condition.

The value u_{k,n}^{L}, in Equation 2 is calculated using Equation 3:

$${u}_{k , n}^{L} = \frac{min ( {r}_{k , n}^{L} \times \frac{{T}_{k , n}^{L}}{{T}_{slot}} , {q}_{k} )}{{r}_{k , n}^{L} \times \frac{{T}_{k , n}^{L}}{{T}_{slot}}} . \qquad [ Eqn . 3 ]$$

In Equation 3, r_{k,n}^{L} is a data rate of an MS k using the subchannel n in the link L,

$$\frac{{T}_{k , n}^{L}}{{T}_{slot}}$$

is a time slot allocated to the MS k using the subchannel n in the link L, and qₖ is the number of packets of the buffered MS k.

The values τₐ and τ_{b}, are calculated using Equation 4:

$${τ}_{a} = \frac{{τ}_{BS \text{-} MS} \times ( T / 2 + {T}_{slot} ) + {τ}_{RS \text{-} MS} \times ( T / 2 - {T}_{slot} )}{T} \\ {τ}_{b} = \frac{{τ}_{BS \text{-} MS} \times ( T / 2 - {T}_{slot} ) + {τ}_{RS \text{-} MS} \times ( T / 2 + {T}_{slot} )}{T} . \qquad [ Eqn . 4 ]$$

In Equation 4, τ_{BS-MS} is a frame rate of the BS-MS link, τ_{RS-MS} is a frame rate of the RS-MS link, T is a total DL frame time, and τₛₗₒₜ is one slot time.

Now, structures and operations of the BS and the RS which allocate resources and communicate are described in detail by referring to the drawings.

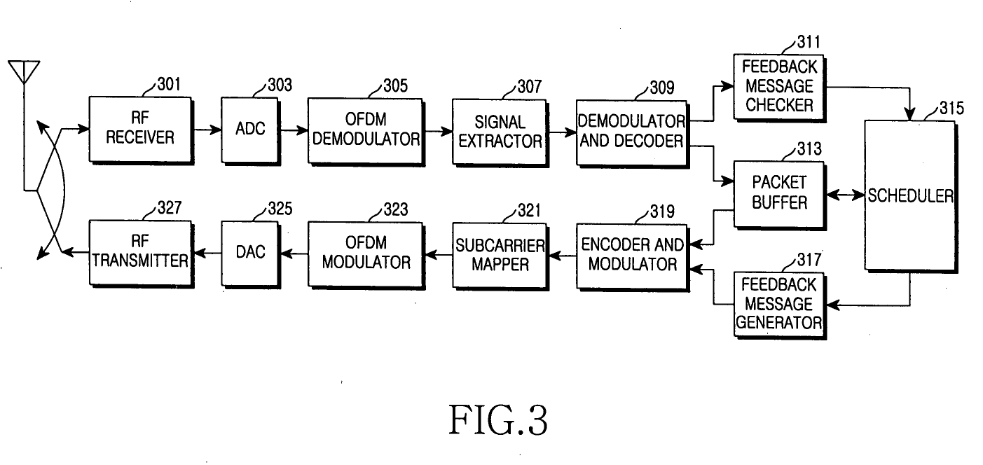

FIG. 3 is a block diagram of the RS in the relay wireless communication system according to an embodiment of the present invention.

The RS of FIG. 3 includes a Radio Frequency (RF) receiver 301, an analog-to-digital converter (ADC) 303, an OFDM demodulator 305, a signal extractor 307, a demodulator and decoder 309, a feedback message checker 311, a packet buffer 313, a scheduler 315, a feedback message generator 317, an encoder and modulator 319, a subcarrier mapper 321, an OFDM modulator 323, a digital-to-analog converter (DAC) 325, and an RF transmitter 327.

The RF receiver 301 converts an RF signal received on an antenna to a baseband analog signal. The ADC 303 converts the analog signal output from the RF receiver 301 to a digital signal. The OFDM demodulator 305 converts the time-domain OFDM symbols output from the ADC 303 to frequency-domain signals using a Fast Fourier Transform (FFT). The signal extractor 307 extracts a receive signal from the frequency-domain signals output from the OFDM demodulator 305. Herein, the receive signal includes data packets and a control signal received from the BS, and a control signal fed back from the MS. The demodulator and decoder 309 converts the signal output from the signal extractor 307 to a bit stream by demodulating and decoding the signal according to a corresponding scheme.

The feedback message checker 311 checks Channel State Information (CSI) (e.g., SINR) of each subchannel of the MS from the message fed back from the MS. The packet buffer 313 stores transmit packets to the MS, which are received from the BS, and outputs the corresponding transmit packets according to the scheduling.

The scheduler 315 schedules the RS-MS link interval of the DL frame. That is, the scheduler 315 allocates resources to the mobile stations communicating via the RS. Particularly, only for mobile stations of which transmit packets are stored to the packet buffer 313, the scheduler 315 first allocates resources to mobile stations of good channel state.

The feedback message generator 317 generates a message indicative of the state of the packet buffer 313. For example, the message indicative of the buffering state includes ID (Identifier) information of mobile stations which have good channel state but of which transmit packets are not buffered. In more detail, the message indicative of the buffering state includes ID information of mobile stations which can be allocated resources by the scheduler 315 according to the priority of the channel state but fail to get the allocated resource because of the unbuffered transmit packets. Alternatively, the message indicative of the buffering state includes ID information of mobile stations of which transmit packets are not buffered regardless of the channel state. The message indicative of the buffering state can include CSI of each MS corresponding to the ID information, in addition to the ID information of the mobile stations. When the BS Tx interval and the RS Tx interval are adjusted in the DL frame, the feedback message generator 317 generates a message including CSI of each subchannel in relation to the mobile stations allocated the resources. Herein, the message indicative of the buffering state and the message including the CSI of each subchannel in relation to the mobile stations allocated the resources can be combined to a single message.

The encoder and modulator 319 converts the bit stream to complex symbols by encoding and modulating the bit stream according to the corresponding scheme. The subcarrier mapper 321 maps the signals output from the encoder and modulator 319 to corresponding subcarriers. The OFDM modulator 323 converts the signals output from the subcarrier mapper 321 to OFDM symbols through an Inverse Fast Fourier Transform (IFFT). The DAC 325 converts the digital signal output from the OFDM modulator 323 to an analog signal. The RF transmitter 327 converts the baseband signal output from the DAC 325 to an RF signal and transmits the RF signal over the antenna.

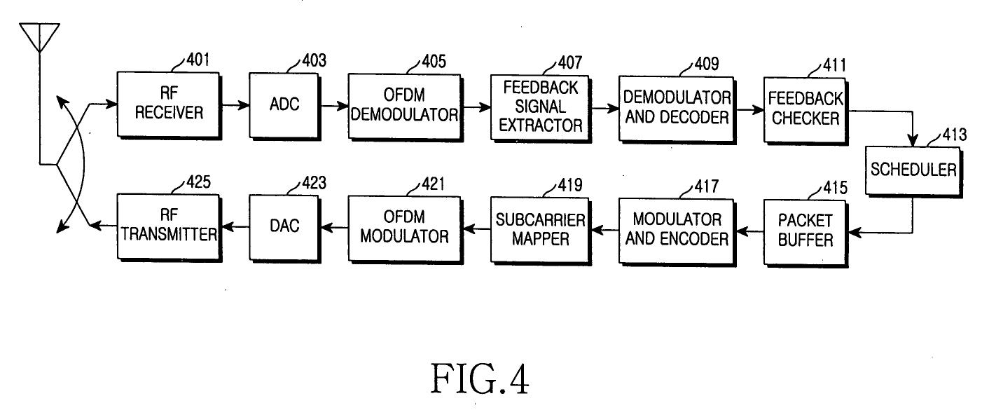

FIG. 4 is a block diagram of the BS in the relay wireless communication system according to an embodiment of the present invention.

The BS of FIG. 4 includes an RF receiver 401, an ADC 403, an OFDM demodulator 405, a feedback signal extractor 407, a demodulator and decoder 409, a feedback message checker 411, a scheduler 413, a packet buffer 415, an encoder and modulator 417, a subcarrier mapper 419, an OFDM modulator 421, a DAC 423, and an RF transmitter 425.

The RF receiver 401 converts an RF signal received on an antenna to a baseband analog signal. The ADC 403 converts the analog signal output from the RF receiver 401 to a digital signal. The OFDM demodulator 405 converts the time-domain OFDM symbols output from the ADC 403 to frequency-domain signals using the FFT. The feedback signal extractor 407 extracts feedback signals received from the RS and the MS, from the frequency-domain signals output from the OFDM demodulator 405. Herein, the feedback signal includes a packet transmission request message fed back from the RS, CSI of each subchannel, and CSI of each subchannel fed back from the MS. The demodulator and decoder 409 converts the signal output from the feedback signal extractor 407 to a bit stream by demodulating and decoding the signal according to a corresponding scheme.

The feedback message checker 411 checks CSI (e.g., SINR) of each subchannel of the MS from the messages fed back from the RS and the MS. Herein, the message fed back from the MS includes CSI between the MS and the BS, and the message fed back from the RS includes CSI between the MS and the RS. The feedback message checker 411 checks the buffering state of the RS from the message fed back from the RS, and selects of which MS the transmit packets to be sent based on the buffering state. For example, the message indicative of the buffering state includes ID information of mobile stations which have the good channel condition but of which transmit packets are not buffered. In other words, the message indicative of the buffering state includes the ID information of the mobile stations which can be allocated the resources by the RS according to the priority of the channel condition but fail to get the allocated resources because of the unbuffered transmit packets. Alternatively, the message indicative of the buffering state includes ID information of mobile stations having the unbuffered transmit packets regardless of the channel condition. The message indicative of the buffering state can include CSI of each MS corresponding to the ID information, in addition to the ID information of the mobile stations.

The scheduler 413 schedules the BS-MS link interval and the BS-RS link of the DL frame. That is, the scheduler 413 allocates resources to the mobile stations and RSs communicating with the BS through the direct links. Particularly, the scheduler 413 identifies an MS of the best channel condition in the subchannels. Next, the scheduler 413 compares the channel condition of the MS identified in the subchannels with the channel condition of the RS, and determines the subchannels of the relatively better channel condition of the RS as the resources for the BS-RS link.

If the amount of the resources determined as the resources for the BS-RS link is insufficient to carry all of the packets requested by the RS, the scheduler 413 reselects part of the selected packets and allocates resources to carry the reselected packets. For example, the scheduler 413 randomly reselects some of the selected packets. Alternatively, the scheduler 413 firstly selects packets of the MS having the good channel condition by referring to the CSI between the RS the MS in the message indicative of the buffering state. By contrast, if the amount of the resources determined as the resources for the BS-RS link is sufficient to carry all of the packets requested by the RS, the scheduler 413 allocates resources to send the requested packets and then allocates the remaining resources to the direct link mobile stations.

When the BS Tx interval and the RS Tx interval are adjusted in the DL frame, the scheduler 413 predicts the BER BER_{k,n}^{L} of each MS using the CSI of each subchannel of each terminal fed back from the RS, and adjusts the BS Tx interval ratio and the RS Tx interval ratio. After initializing the BS Tx interval and the RS Tx interval to the same time length, the scheduler 413 compares the frame rate τₖ when the two Tx interval are equal, the frame rate τₐ when the BS Tx interval is increased by one time slot, and the frame rate τ_{b} when the RS Tx interval is increased by one time slot. Next, the scheduler 413 adjusts the ratio of the Tx interval to make the highest frame rate, and optimizes the Tx interval ratios by repeating the comparison of the frame rates in those three cases. That is, when the case of the highest frame rate is the same as the pre-adjusted situation in the process of the repetitions, the scheduler 413 determines that the Tx interval adjustment is optimized. Herein, the frame rates in the three cases are calculated using Equation 1 and Equation 4.

The packet buffer 415 stores the packets to be sent to the RS and the mobile stations and outputs the corresponding transmit packets according to the scheduling. The encoder and modulator 417 converts the bit stream to complex symbols by encoding and modulating the bit stream according to the corresponding scheme. The subcarrier mapper 419 maps the signals output from the encoder and modulator 417 to corresponding subcarriers. The OFDM modulator 421 converts the signals output from the subcarrier mapper 419 to OFDM symbols through the IFFT. The DAC 423 converts the digital signal output from the OFDM modulator 421 to an analog signal. The RF transmitter 425 converts the baseband signal output from the DAC 423 to an RF signal and transmits the RF signal over the antenna.

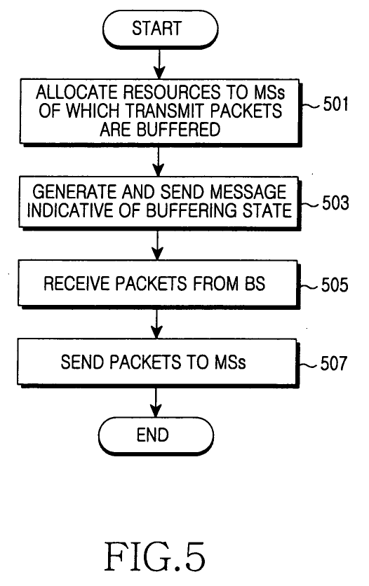

FIG. 5 illustrates a resource allocating method of the RS in the relay wireless communication system according to an embodiment of the present invention. Particularly, FIG. 5 depicts a case where the BS Tx interval and the RS Tx interval are fixed in the DL frame. The operations in FIG. 5 are performed during one DL frame.

In step 501, the RS allocates the resources to the mobile stations of which the transmit packets are buffered. The resources are allocated first to the mobile stations of the good channel condition.

In step 503, the RS generates and transmits the message indicative of the buffering state. For example, the message includes ID information of the mobile stations which have the good channel condition but of which transmit packets are not buffered. In other words, the message includes the ID information of the mobile stations which can be allocated the resources based on the priority of the channel condition in step 503 but fail to get the allocated resources because of the unbuffered transmit packets. Alternatively, the message includes ID information of the mobile stations of which transmit packets are not buffered regardless of channel condition. In addition to the ID information of the mobile stations, the message can include CSI of each MS corresponding to the ID information.

After sending the message indicative of the buffering state, the RS receives packets from the BS through the resources for the BS-RS link during the DL frame in step 505. The received packets can be all or part of the transmit packets destined for the mobile stations of which the ID information are contained in the message indicative of the buffering state.

In step 507, the RS transmits the packets to the MS in the remaining DL frame interval. The transmitted packets are scheduled in step 501. The transmit packets received in step 505 are scheduled and transmitted in the next frame.

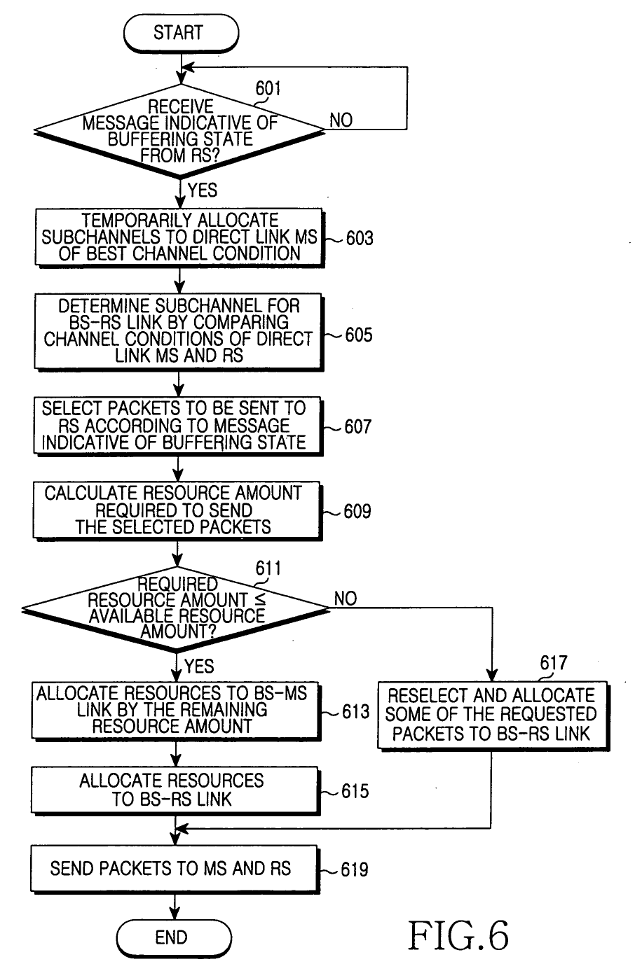

FIG. 6 illustrates a resource allocating method of the BS in the relay wireless communication system according to an embodiment of the present invention. Particularly, FIG. 6 illustrates a case where the BS Tx interval and the RS Tx interval are fixed in the DL frame. The operations of FIG. 6 are performed during one DL frame.

In step 601, the BS checks whether the message indicative of the buffering state is received from the RS. For example, the message includes ID information of the mobile stations which have the good channel condition but of which transmit packets are not buffered. In other words, the message includes the ID information of the mobile stations which can be allocated the resources based on the priority of the channel condition but fail to get the allocated resources because of their unbuffered transmit packets. Alternatively, the message includes ID information of the mobile stations of which transmit packets are not buffered regardless of the channel condition. In addition to the ID information of the mobile stations, the message can include CSI of each MS corresponding to the ID information.

Upon receiving the message indicative of the buffering state, the BS temporarily allocates subchannels to mobile stations having the best direct link channel condition based on the subchannels in the Tx interval used for the BS communications in step 603. Namely, the BS temporarily allocates all of the resources in the BS Tx interval to the direct link mobile stations without considering the BS-RS link.

In step 605, the BS compares the channel condition of the direct link MS for each subchannel with the channel condition of the RS and determines the resources used as the BS-RS link according to the comparison result. In more detail, the BS determines the subchannel temporarily allocated to the direct link MS of the channel condition poorer than the channel condition of the RS as the resources for the BS-RS link. The other subchannels, excluding the resources used as the BS-RS link, are used as temporarily allocated in step 603.

Next, the BS selects packets to be sent to the RS according to the message indicative of the buffering state in step 607. That is, the BS selects the packets of the mobile stations of which the ID information is contained in the message.

In step 609, the BS calculates the amount of the resources required to send the selected packets. The BS calculates the amount of the resources required to send all the selected packets.

In step 611, the BS compares the calculated resource amount with the amount of available resources. Herein, the amount of the available resources is the amount of the resources determined for the BS-RS link in step 605.

When the required resource amount is less than or equal to the available resource amount, the BS allocates the remaining resources; that is, the resources as much as the difference between the available resource amount and the required resource amount to the BS-MS link in step 613.

Next, the BS allocates the remaining resources to the BS-RS link in step 615.

By contrast, when the required resource amount is greater than the available resource amount, the BS reselects some of the selected packets and allocates the available resources to the BS-RS link in step 617. That is, the BS allocates the available resources to send the selected packets. For example, the BS randomly reselects some of the selected packets. Alternatively, the BS firstly reselects the packets of the MS having the good channel condition by referring to the CSI between the RS and the mobile stations contained in the message received in step 601.

Next, the BS transmits the packets to the MS and the RS according to the resource allocation in step 619.

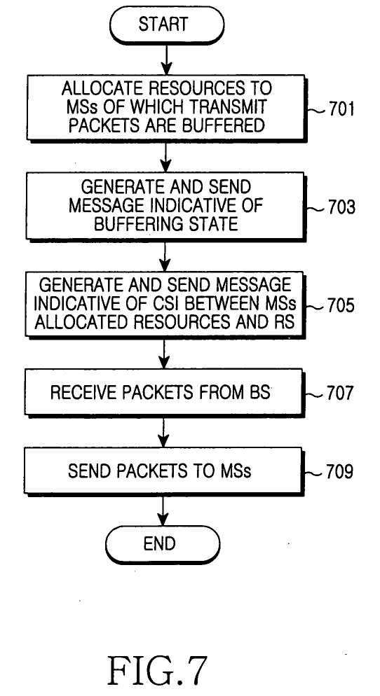

FIG. 7 illustrates a resource allocating method of the RS in the relay wireless communication system according to another embodiment of the present invention. Particularly, FIG. 7 illustrates a case where the BS Tx interval and the RS Tx interval are adjusted in the DL frame. The operations of FIG. 7 are performed over one DL frame.

In step 701, the RS allocates resources to the mobile stations of which the transmit packets are buffered. The resources are allocated first to the mobile stations of the good channel condition.

In step 703, the RS generates and sends the message indicative of the buffering state. For example, the message includes ID information of mobile stations of which the channel condition is good but the transmit packets are not buffered. In other words, the message includes the ID information of the mobile stations which can be allocated the resources based on the priority of the channel condition but fail to get the allocated resources because of the unbuffered transmit packets. Alternatively, the message includes ID information of the mobile stations of which transmit packets are not buffered regardless of the channel condition. In addition to the ID information of the mobile stations, the message can include CSI of each MS corresponding to the ID information.

In step 705, the RS generates and sends the message including the CSI of each subchannel between the mobile stations allocated the resources in step 701 and the RS. Herein, the message indicative of the buffering state in step 701 and the message including the CSI of the subchannels between the mobile stations allocated the resources and the RS in step 705 can be unified as a single message.

In step 707, the RS receives packets from the BS through the resources for the BS-RS link during the DL frame interval. The received packets can be all or part of the transmit packets destined for the mobile stations of which the ID information is contained in the message indicative of the buffering state.

In step 709, the RS transmits the packets to the MS during the remaining DL frame interval. The transmitted packets are scheduled in step 701. The transmit packets received in step 707 are scheduled and transmitted in the next frame.

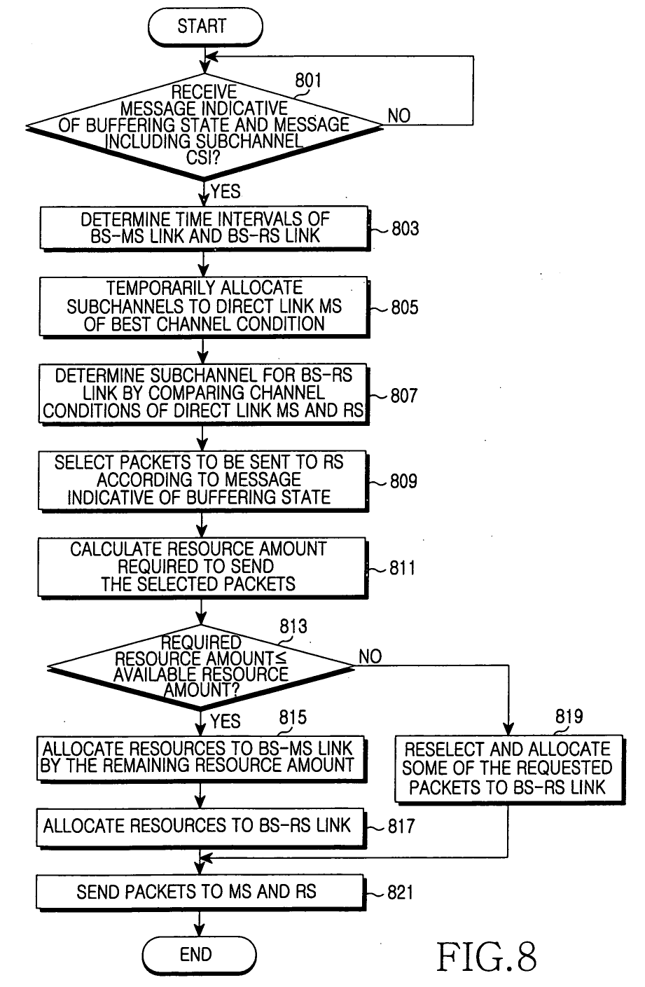

FIG. 8 illustrates a resource allocating method of the BS in the relay wireless communication system according to another embodiment of the present invention. Particularly, FIG. 8 illustrates a case where the BS Tx interval and the RS Tx interval are adjusted in the DL frame. The operations of FIG. 8 are performed during one DL frame.

In step 801, the BS checks whether the single message including the message indicative of the buffering state and the message containing the

between the MS and the RS is received or not. Herein, the message indicative of the buffering state includes the ID information of the mobile stations of which the transmit packets are not buffered. If the message indicative of the buffering state includes no ID information, the BS determines that there is no transmit request packet. The message indicative of the buffering state may include the CSI of the RS and the CSI of each MS corresponding to the requested packets. Herein, the message indicative of the buffering state and the message containing the CSI of each subchannel between the mobile stations allocated the resources and the RS can be unified as a single message.

Upon receiving the message indicative of the buffering state and the message containing the CSI of each subchannel between the mobile stations allocated the resources and the RS, the BS estimates BER_{k,n}^{L} of each MS using the CSI of each subchannel between the MS and the RS and adjusts the BS Tx interval and the RS Tx interval in step 803. After initializing the BS Tx interval and the RS Tx interval to the same time length, the BS compares the frame rate τₖ when the two Tx interval are equal, the frame rate τₐ when the BS Tx interval is increased by one time slot, and the frame rate τ_{b} when the RS Tx interval is increased by one time slot. Next, the BS adjusts the ratio of the Tx interval to make the highest frame rate, and optimizes the Tx interval ratios by repeating the comparison of the frame rates in those three cases. That is, when the case of the highest frame rate is the same as the pre-adjusted situation in the process of the repetitions, the BS determines that the Tx interval adjustment is optimized. Herein, the frame rates in the three cases are calculated using Equation 1 and Equation 4.

In step 805, the BS temporarily allocates subchannels to mobile stations having the best direct link channel condition based on the subchannel in the BS Tx interval. Namely, the BS temporarily allocates all resources to the direct link mobile stations without considering the BS-RS link.

In step 807, the BS compares the channel condition of the direct link MS for each subchannel with the channel condition of the RS and determines the resources used as the BS-RS link according to the comparison result. In more detail, the BS determines the subchannel temporarily allocated to the direct link MS of the channel condition poorer than the channel condition of the RS as the resources for the BS-RS link. The other subchannels, excluding the resources used as the BS-RS link, are used as temporarily allocated in step 805.

Next, the BS selects packets to be sent to the RS according to the message indicative of the buffering state in step 809. That is, the BS selects the packets of the mobile stations of which the ID information is contained in the message.

In step 811, the BS calculates the amount of the resources required to send the selected packets. That is, the BS calculates the amount of the resources required to send all the selected packets.

In step 813, the BS compares the calculated resource amount with the amount of available resources. Herein, the amount of the available resources is the amount of the resources determined for the BS-RS link in step 807.

When the required resource amount is less than or equal to the available resource amount, the BS allocates the remaining resources; that is, the resources as much as the difference between the available resource amount and the required resource amount to the BS-MS link in step 815.

Next, the BS allocates the remaining resources to the BS-RS link in step 817.

By contrast, when the required resource amount is greater than the available resource amount, the BS reselects some of the selected packets and allocates the available resources to the BS-RS link in step 819. That is, the BS allocates the available resources to send the selected packets. For example, the BS randomly reselects some of the selected packets. Alternatively, the BS firstly reselects the packets of the MS having the good channel condition by referring to the CSI between the RS and the mobile stations contained in the message received in step 801.

Next, the BS transmits the packets to the MS and the RS according to the resource allocation in step 821.

As set forth above, since the resources are allocated by taking into account the buffering state of the RS in the relay wireless communication system, the effective relay communication can be realized. Additionally, the total system throughput can be increased by adjusting the ratio of the Tx interval for the relay communication by considering the channel condition between the RS and the MS.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A relay station in a relay wireless communication system, comprising:
a buffer for storing packets to be sent to at least one mobile station;
a scheduler for allocating resources to the at least one mobile station of which the packets are stored to the buffer;
a generator for generating a message which comprises information about at least one mobile station of which packets are not stored to the buffer; and
a communicator for sending the message to a base station and sending the packets stored to the buffer to the at least one mobile station allocated the resources.

2. The relay station of claim 1, wherein the scheduler allocates the resources to at least one mobile station of which packets are stored to the buffer, based on a priority of a channel condition.

3. The relay station of claim 1, wherein the generator generates a message which comprises information about at least one mobile station which is not allocated resources because packets of the at least one mobile station are not stored to the buffer in spite of good channel condition.

4. The relay station of claim 1, wherein the message comprises ID (Identifier) information of at least one mobile station of which packets are not stored to the buffer, or Channel State Information (CSI) of the at least one mobile station of which the packets are not stored to the buffer.

5. The relay station of claim 1, further comprising:
a checker for checking CSI of each subchannel, which is fed back from at least one mobile station communicating in a relay manner.

6. The relay station of claim 5, wherein the generator generates a message comprising CSI of each subchannel about the at least one mobile station allocated the resources, and
the communicator transmits the message to the base station.

7. A base station in a relay wireless communication system, comprising:
a checker for checking a message indicative of a buffering state of a relay station, the message received from the relay station;
a scheduler for selecting at least one packet to be sent to the relay station according to the message, determining at least one subchannel where there is no direct link mobile station having better channel condition than a channel condition of the relay station, as resources for communicating with the relay station, and allocating the resources for communicating with the relay station to send the at least one selected packet; and
a communicator for transmitting the at least one packet to the relay station.

8. The base station of claim 7, wherein the message comprises ID (IDentifier) information of at least one mobile station of which packets are not stored to a buffer of the relay station, or Channel State Information (CSI) of the at least one mobile station of which the packets are not stored to the buffer of the relay station.

9. The base station of claim 8, wherein the scheduler calculates an amount of resources required to send the at least one selected packet, and randomly reselects part of the at least one selected packet when the an amount of resources for communicating with the relay station is less than the amount of the required resources.

10. The base station of claim 8, wherein the scheduler calculates an amount of resources required to send the at least one selected packet, and reselects part of the at least one selected packet according to a priority of the channel condition when the an amount of resources for communicating with the relay station is less than the amount of the required resources.

11. The base station of claim 7, wherein the scheduler calculates an amount of resources required to send the at least one selected packet, and allocates resources corresponding to a difference between the resource amount for communicating with the relay station and the required resource amount, to the direct link mobile station when the amount of resources for communicating with the relay station is greater than the amount of the required resources.

12. The base station of claim 9, wherein the checker checks CSI of each subchannel about each mobile station, which is fed back from the relay station.

13. The base station of claim 12, wherein the scheduler adjusts ratios of a base station Tx interval and a relay station Tx interval in a DownLink (DL) frame using the CSI of each subchannel about each mobile station.

14. The base station of claim 13, wherein the scheduler initializes time lengths of the base station Tx interval and the relay station Tx interval to the same length, calculates frame rates in a first case of the initialization, a second case where the base station Tx interval is increased by one time slot, and a third case where the relay station Tx interval is increased by one time slot, and adjusts the Tx intervals to correspond to the highest frame rate.

15. The base station of claim 14, wherein, when the first case corresponds to the highest frame rate, the scheduler determines that the Tx interval adjustment is optimized.

16. The base station of claim 14, wherein, when the second case or the third case corresponds to the highest frame rate, the scheduler adjusts the Tx intervals and repeats the Tx interval adjustment.

17. The base station of claim 14, wherein the scheduler calculates the frame rate of the first case using the following equations:
$$\frac{{τ}_{BS \text{-} MS} \times T / 2 + {τ}_{RS \text{-} MS} \times T / 2}{T} , \\ \begin{matrix}{τ}_{L} = {\sum }_{k} {τ}_{k}^{L} \\ = \frac{1}{N} {\sum }_{n} {\sum }_{k} {τ}_{k , n}^{L} \\ = \frac{1}{N} {\sum }_{n} {\sum }_{k} {c}_{k , n}^{L} \times {u}_{k , n}^{L} \times {r}_{k , n}^{L} \times ( 1 - {BER}_{k , n}^{L} \times {r}_{k , n}^{L} ) ,\end{matrix}$$
$$and$$
$${u}_{k , n}^{L} = \frac{min ( {r}_{k , n}^{L} \times \frac{{T}_{k , n}^{L}}{{T}_{slot}} , {q}_{k} )}{{r}_{k , n}^{L} \times \frac{{T}_{k , n}^{L}}{{T}_{slot}}} ,$$
where τ_{BS-MS} is a frame rate of a base station-mobile station link, τ_{RS-MS} is a frame rate of a relay station-mobile station link, T is a total DL frame time, τ_{L} is a frame rate for a random link L, k is an mobile station index in the link L, N is a number of subchannels, n is a subchannel index, c_{k,n}^{L} is an indicator which is set to 1 when the mobile station k uses the subchannel n in the link L and set to 0 in other cases, u_{k,n}^{L} is an index indicative of channel utilization, r_{k,n}^{L} is a data rate of the mobile station k using the subchannel n in the link L, BER_{k,n}^{L} is a Bit Error Rate (BER) of the mobile station k using the subchannel n in the link L estimated based on CSI,
$$\frac{{T}_{k , n}^{L}}{{T}_{slot}}$$
is a time slot allocated to the mobile station k using the subchannel n in the link L, and qₖ is a number of packets of the buffered mobile station k.

18. The base station of claim 14, wherein the scheduler calculates the frame rate of the second case using the following equation:
$$\frac{{τ}_{BS \text{-} MS} \times ( T / 2 + {T}_{slot} ) + {τ}_{RS \text{-} MS} \times ( T / 2 - {T}_{slot} )}{T}$$
where τ_{BS-MS} is a frame rate of the base station-mobile station link, τ_{RS-MS} is a frame rate of the relay station-mobile station link, T is a total DL frame time, and Tₛₗₒₜ is one slot time.

19. The base station of claim 14, wherein the scheduler calculates the frame rate of the third case using the following equation:
$$\frac{{τ}_{BS \text{-} MS} \times ( T / 2 - {T}_{slot} ) + {τ}_{RS \text{-} MS} \times ( T / 2 + {T}_{slot} )}{T}$$
where τ_{BS-MS} is a frame rate of the base station-mobile station link, τ_{RS-MS} is a frame rate of the relay station-mobile station link, T is a total DL frame time, and Tₛₗₒₜ is one slot time.

20. An operating method of a relay station in a relay wireless communication system, the method comprising:
allocating resources to at least one mobile station of which packets are buffered;
generating and sending a message which comprises information about at least one mobile station of which packets are not buffered; and
sending the buffered packets to the at least one mobile station allocated the resources.

21. The operating method of claim 20, wherein the resource allocating allocates the resources to at least one mobile station of which packets are buffered, based on a priority of a channel condition.

22. The operating method of claim 20, wherein the message comprises information about at least one mobile station which is not allocated resources because packets of the at least one mobile station are not buffered in spite of good channel condition.

23. The operating method of claim 20, wherein the message comprises ID (Identifier) information of at least one mobile station of which packets are not buffered, or Channel State Information (CSI) of the at least one mobile station of which the packets are not buffered.

24. The operating method of claim 20, further comprising:
receiving CSI of each subchannel, which is fed back from at least one mobile station communicating in a relay manner.

25. The operating method of claim 24, further comprising:
generating and sending a message comprising CSI of each subchannel about the at least one mobile station allocated the resources.

26. An operating method of a base station in a relay wireless communication system, the method comprising:
receiving a message indicative of a buffering state of a relay station from the relay station;
determining at least one subchannel where there is no direct link mobile station having better channel condition than a channel condition of the relay station, as resources for communicating with the relay station;
selecting at least one packet to be sent to the relay station according to the message and allocating the resources for communicating with the relay station to send the at least one selected packet; and
transmitting the at least one packet to the relay station.

27. The operating method of claim 26, wherein the message comprises ID (IDentifier) information of at least one mobile station of which packets are not stored to a buffer of the relay station, or Channel State Information (CSI) of the at least one mobile station of which the packets are not stored to the buffer of the relay station.

28. The operating method of claim 27, wherein the allocating of the resources for communicating with the relay station to send the at least one selected packet comprises:
calculating an amount of resources required to send the at least one selected packet;
randomly reselecting part of the at least one selected packet when the an amount of resources for communicating with the relay station is less than the amount of the required resources; and
allocating resources to send the reselected packets.

29. The operating method of claim 27, wherein the allocating of the resources for communicating with the relay station to send the at least one selected packet, comprises:
calculating an amount of resources required to send the at least one selected packet;
reselecting part of the at least one selected packet according to a priority of the channel condition when the an amount of resources for communicating with the relay station is less than the amount of the required resources; and
allocating resources to send the reselected packets.

30. The operating method of claim 26, further comprising:
calculating an amount of resources required to send the at least one selected packet; and
allocating resources corresponding to a difference between the resource amount for communicating with the relay station and the required resource amount, to the direct link mobile station when the amount of resources for communicating with the relay station is greater than the amount of the required resources.

31. The operating method of claim 26, further comprising:
receiving CSI of each subchannel about each mobile station, which is fed back from the relay station.

32. The operating method of claim 31, further comprising:
adjusting ratios of a base station Tx interval and an relay station Tx interval in a DownLink (DL) frame using the CSI of each subchannel about each mobile station.

33. The operating method of claim 32, wherein the adjusting of the Tx interval ratios comprises:
initializing time lengths of the base station Tx interval and the relay station Tx interval to the same length;
calculating frame rates in a first case of the initialization, a second case where the base station Tx interval is increased by one time slot, and a third case where the relay station Tx interval is increased by one time slot; and
adjusting the Tx intervals to correspond to the highest frame rate.

34. The operating method of claim 33, further comprising:
determining that the Tx interval adjustment is optimized when the first case corresponds to the highest frame rate.

35. The operating method of claim 33, further comprising:
adjusting the Tx intervals and repeating the Tx interval adjustment when the second case or the third case corresponds to the highest frame rate.

36. The operating method of claim 33, wherein the frame rate of the first case is calculated using the following equations:
$$\frac{{τ}_{BS \text{-} MS} \times T / 2 + {τ}_{RS \text{-} MS} \times T / 2}{T} , \\ \begin{matrix}{τ}_{L} = {\sum }_{k} {τ}_{k}^{L} \\ = \frac{1}{N} {\sum }_{n} {\sum }_{k} {τ}_{k , n}^{L} \\ = \frac{1}{N} {\sum }_{n} {\sum }_{k} {c}_{k , n}^{L} \times {u}_{k , n}^{L} \times {r}_{k , n}^{L} \times ( 1 - {BER}_{k , n}^{L} \times {r}_{k , n}^{L} ) ,\end{matrix}$$
$$and$$
$${u}_{k , n}^{L} = \frac{min ( {r}_{k , n}^{L} \times \frac{{T}_{k , n}^{L}}{{T}_{slot}} , {q}_{k} )}{{r}_{k , n}^{L} \times \frac{{T}_{k , n}^{L}}{{T}_{slot}}} ,$$
where τ_{BS-MS} is a frame rate of a base station-mobile station link, τ_{RS-MS} is a frame rate of an relay station-mobile station link, T is a total DL frame time, τ_{L} is a frame rate for a random link L, k is an mobile station index in the link L, N is a number of subchannels, n is a subchannel index, c_{k,n}^{L} is an indicator which is set to 1 when the mobile station k uses the subchannel n in the link L and set to 0 in other cases, u_{k,n}^{L} is an index indicative of channel utilization, r_{k,n}^{L} is a data rate of the mobile station k using the subchannel n in the link L, BER_{k,n}^{L} is a Bit Error Rate (BER) of the mobile station k using the subchannel n in the link L estimated based on CSI,
$$\frac{{T}_{k , n}^{L}}{{T}_{slot}}$$
is a time slot allocated to the mobile station k using the subchannel n in the link L, and qₖ is a number of packets of the buffered mobile station k.

37. The operating method of claim 33, wherein the frame rate of the second case is calculated using the following equation:
$$\frac{{τ}_{BS \text{-} MS} \times ( T / 2 + {T}_{slot} ) + {τ}_{RS \text{-} MS} \times ( T / 2 - {T}_{slot} )}{T}$$
where τ_{BS-MS} is a frame rate of the base station-mobile station link, τ_{RS-MS} is a frame rate of the relay station-mobile station link, T is a total DL frame time, and Tₛₗₒₜ is one slot time.

38. The operating method of claim 33, wherein the frame rate of the third case is calculated using the following equation:
$$\frac{{τ}_{BS \text{-} MS} \times ( T / 2 - {T}_{slot} ) + {τ}_{RS \text{-} MS} \times ( T / 2 + {T}_{slot} )}{T}$$
where τ_{BS-MS} is a frame rate of the base station-mobile station link, τ_{RS-MS} is a frame rate of the relay station-mobile station link, T is a total DL frame time, and Tₛₗₒₜ is one slot time.
